(19) United States
(12) Patent Application Publication
(10) Pub. No.: US 2019/0165337 A1
(43) Pub. Date: May 30, 2019

(54) BATTERY CASING AND BATTERY MODULE INCLUDING THE SAME

(71) Applicant: SAMSUNG ELECTRONICS CO., LTD., Suwon-si (KR)

(72) Inventors: Kyeong PANG, Suwon-si (KR); Feifei FANG, Suwon-si (KR); In KIM, Suwon-si (KR); In Su LEE, Hwaseong-si (KR); Hye Jeong LEE, Suwon-si (KR); Ginam KIM, Seongnam-si (KR)

(21) Appl. No.: 16/204,333

(22) Filed: Nov. 29, 2018

(30) Foreign Application Priority Data
Nov. 30, 2017 (KR) 10-2017-0163680

(51) Int. Cl. H01M 2/02

(52) U.S. Cl. CPC H01M 2/0262; H01M 2/0202

(57) ABSTRACT

A battery casing including a container configured to house an electrode assembly, wherein the container includes a bottom wall and a plurality of side walls configured to define an open side opposite to the bottom wall and to define a space for housing the electrode assembly, at least one of the bottom wall and the plurality of side walls includes a composition including a base polymer and a plurality of nucleating agent particles dispersed in the base polymer, the base polymer includes a polyethylene polymer, the nucleating agent particles have a rod shape, the aspect ratio of the nucleating agent particles is greater than or equal to about 2, and an amount of the nucleating agent particles is about 0.01 parts by weight to about 3 parts by weight, based on 100 parts by weight of the base polymer.

### CROSS-REFERENCE TO RELATED APPLICATION

This application claims priority to and the benefit of Korean Patent Application No. 10-2017-0163680 filed in the Korean Intellectual Property Office on Nov. 30, 2017, the entire content of which is incorporated herein by reference.

### BACKGROUND

### 1. Field

A battery casing and a battery module including the same are disclosed.

### 2. Description of the Related Art

As various types of mobile electronic devices and various types of electric transportation are developed, there is a need for improved power sources (e.g., a battery) for supplying the electronic devices/transportation with electricity (or motive power).

The battery may be housed in a casing and disposed individually or as a module in the electronic devices or means of transportation. Accordingly, development of technology capable of improving properties of the casing is required.

### SUMMARY

An embodiment provides a battery casing having improved properties.

Another embodiment provides a battery or a battery module including the battery casing.

In an embodiment, a battery casing includes a container configured to house an electrode assembly, wherein the container includes a bottom wall and a plurality of side walls,

the bottom wall and the plurality of side walls are integrated to define an open side opposite to the bottom wall and to define a space for housing the electrode assembly,

at least one of the bottom wall and the plurality of side walls includes a composition including a base polymer and a plurality of nucleating agent particles dispersed in the base polymer, the base polymer includes a polyethylene polymer, the plurality of the nucleating agent particles have a rod shape, an aspect ratio of the nucleating agent particle is greater than or equal to about 2, and an amount of the nucleating agent particle is greater than or equal to about 0.01 parts by weight and less than or equal to about 3 parts by weight, based on 100 parts by weight of the base polymer.

The container may further include a plurality of cell compartments separated by at least one partition wall disposed in the space.

The battery casing may further include a lid configured to cover at least a portion of the open side of the container and including at least one of a positive terminal and a negative terminal.

The lid may include a material which is the same as a material of the container.

The composition may include the nucleating agent particles in an amount of greater than or equal to about 0.04 parts by weight and less than or equal to 1 part by weight, based on 100 parts by weight of the base polymer.

The average aspect ratio of the nucleating agent particles may be greater than or equal to about 3.

The average aspect ratio of the nucleating agent particles may be less than or equal to about 15.

An average length of the nucleating agent particles may be greater than or equal to about 0.5 micrometers (μm) and less than or equal to about 20 μm.

At least a portion of the nucleating agent particles may have a circular or polygonal cross-section.

A ratio of a circumference (e.g., the longest circumference) of a cross-section of the nucleating agent particle to the thickness of the nucleating agent particle is less than or equal to about 20.

The nucleating agent particles may include a metal salt having a hexahydrophthalate moiety, a phosphate metal salt, a titanium-potassium-niobium composite oxide, or a combination thereof.

The nucleating agent particles may not include a surface-treatment including an organic compound.

The polyethylene polymer may include a high density polyethylene.

A melt flow index of the base polymer may be greater than or equal to about 0.01 grams per 10 minutes (g/10 min) and less than or equal to about 5 g/10 min, as measured at 190° C. under a load of 2.16 kilograms (kg).

A density of the polyethylene polymer may be greater than or equal to about 0.9 grams per cubic centimeter (g/cc).

At least one of the bottom wall and the plurality of side walls including the composition may include a molded article.

The molded article may have a crystallinity of greater than or equal to about 71% as confirmed by a differential scanning calorimeter (DSC).

The molded article may have a tensile strength of greater than or equal to about 250 kilogram force per square centimeter (kgf/cm²), as measured at a tensile speed of 50 millimeters per minute (mm/min) according to ASTM D638.

The molded article may have an impact strength of greater than or equal to about 30 kilojoules per square meter (kJ/m²), as measured according to ASTM D265.

The molded article may have a water vapor transmittance rate (WVTR) of less than or equal to about 0.5 grams per square meter per day (g/m² day), for example less than or equal to about 0.45 g/m² day, as measured at 38° C. and a relative humidity of 100% according to ISO 15106 and ASTM F 1249.

In another embodiment, a battery includes the battery casing and an electrode assembly, and the electrode assembly is housed in the container of the battery casing.

The battery may have a modular shape and includes a plurality of electrode assemblies.

The battery casing according to an embodiment has improved mechanical properties and improved moisture transmission resistivity. Therefore, the battery or the battery module including the same may be used for various electronic devices and electric transportation.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is an exploded perspective view of a battery casing according to an embodiment.

FIG. 2 is an exploded perspective view of a battery casing according to another embodiment.

FIG. 3 is a schematic view showing a formation process of a spherical shaped polymer crystal in the absence of a nucleating agent particle.

FIG. 4 is a schematic view showing a formation process of a spherical shaped polymer crystal in the presence of a nucleating agent particle.

FIG. 5 is a schematic view showing the formation process of polymer crystal a in a composition according to non-limiting embodiment.

FIG. 6 is a schematic view showing a method of obtaining polymer pellets in accordance with the examples.

FIG. 7 shows a scanning electron microscopic (SEM) image of the nucleating agent particles included in the composition according to Example 1-1.

FIG. 8 shows a scanning electron microscopic image of the nucleating agent particles included in the composition according to Example 2-1.

FIG. 9 shows a scanning electron microscopic image of the nucleating agent particles included in the composition according to Example 3-1.

FIG. 10 shows a scanning electron microscopic image of the nucleating agent particles included in the composition according to Comparative Example 2.

FIG. 11 shows a scanning electron microscopic image of the nucleating agent particles included in the composition according to Comparative Example 3.

FIG. 12 shows a scanning electron microscopic image of the nucleating agent particles included in the composition according to Comparative Example 4.

FIG. 13 shows a scanning electron microscopic image of the nucleating agent particles included in the composition according to Comparative Example 5.

FIG. 14 shows a scanning electron microscopic image of the nucleating agent particles included in the composition according to Comparative Example 6.

FIG. 15 shows a scanning electron microscopic image of the nucleating agent particles included in the composition according to Comparative Example 7.

FIG. 16 shows a scanning electron microscopic image of the nucleating agent particles included in the composition according to Comparative Example 8.

FIG. 17 shows a scanning electron microscopic image of the nucleating agent particles included in the composition according to Comparative Example 9.

FIG. 18 shows a scanning electron microscopic image of the nucleating agent particles included in the composition according to Comparative Example 10.

FIG. 19A and FIG. 19B are each a view schematically illustrating the nucleating agent particle of an embodiment.

### DETAILED DESCRIPTION

Advantages and characteristics of this disclosure, and a method for achieving the same, will become evident referring to the following example embodiments together with the drawings attached hereto. However, the embodiments should not be construed as being limited to the embodiments set forth herein. If not defined otherwise, all terms (including technical and scientific terms) in the specification may be defined as commonly understood by one skilled in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. In addition, the term “comprise” and variations such as “comprises” or “comprising,” will be understood to imply the inclusion of stated elements but not the exclusion of any other elements.

Further, the singular includes the plural unless mentioned otherwise.

In the drawings, the thickness of layers, regions, etc., are exaggerated for clarity. Like reference numerals designate like elements throughout the specification.

It will be understood that when an element such as a layer, film, region, or plate is referred to as being “on” another element, it can be directly on the other element or intervening elements may also be present. In contrast, when an element is referred to as being “directly on” another element, there are no intervening elements present.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or 5% of the stated value.

As used herein, “polyethylene polymer” refers to a polymer including a repeating unit derived from ethylene.

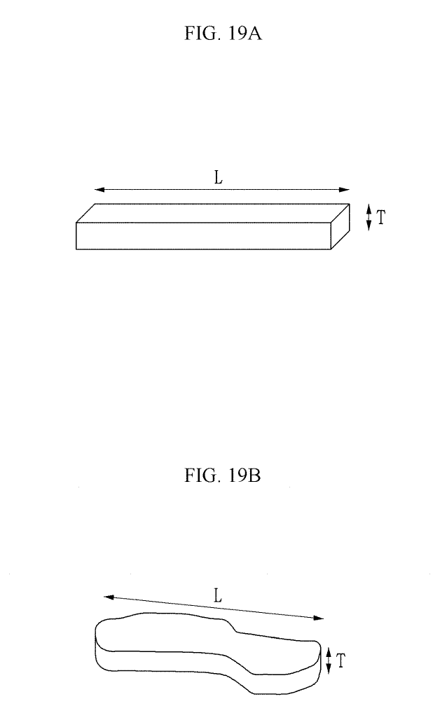

A battery casing according to an embodiment includes a container configured to house an electrode assembly. The container includes a bottom wall and a plurality of side walls. The bottom wall and the plurality of side walls are integrated (configured) to define an open side opposite to the bottom wall and to define a space for housing the electrode assembly. At least one of the bottom wall and the plurality of side walls (e.g., both the bottom wall and the plurality of side walls) includes a composition including a base polymer and a plurality of nucleating agent particles dispersed in the base polymer. The base polymer includes a polyethylene polymer (e.g., a linear polyethylene polymer). The nucleating agent particles have a rod shape and an aspect ratio of greater than or equal to about 2. The aspect ratio is defined as a ratio of the length (i.e., the largest length, L) to the thickness (T) of the particle. (For example, see FIGS. 19A and 19B). The nucleating agent particles are included in the composition in an amount of greater than or equal to about 0.01 parts by weight and less than or equal to about 3 parts by weight per 100 parts by weight of the base polymer. At least one of the bottom wall and the plurality of side walls, for example, each of the bottom wall and the plurality of the side walls including the composition may include (e.g. in the form of) a molded article of the composition.

As used herein, the term “linear polyethylene polymer” refers to a polyethylene polymer produced using a transition metal catalyst (e.g., Ziegler-Natta catalyst, chromium catalyst, single site catalyst, or metallocene catalyst, etc.).

Herein, “integrated” refers to the case in which a plurality of elements (e.g., bottom wall and/or upper wall) are combined with a junction part or a seam connecting the combined elements and also to a case where the plurality of the elements are connected to one another without the junction part or the seam. In some embodiments, the plurality of the elements may be combined, for example, by using a mold having a desired shape. In other embodiments, adjacent components can be glued together or mechanically connected.

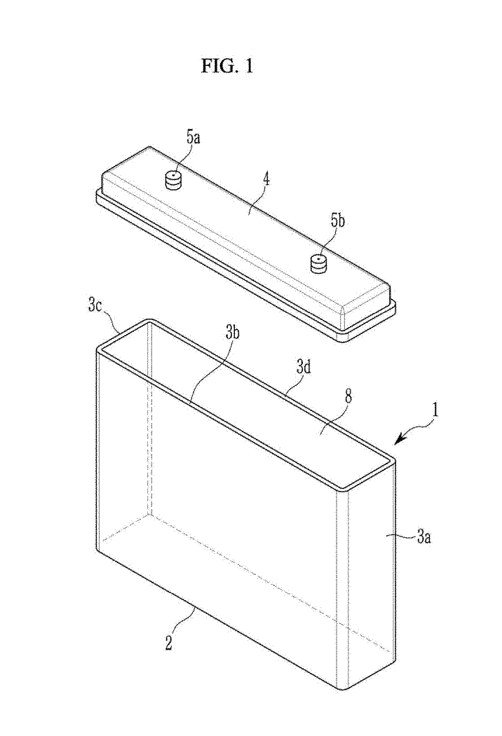

FIG. 1 is an exploded perspective view of a battery casing according to an embodiment. Referring to FIG. 1, in a battery casing according to an embodiment, a bottom wall 2 and a plurality of side walls 3a, 3b, 3c, and 3d are integrated to provide a container 1. The number of the plurality of side walls may be 3, 4, or greater. A manner of the integration is not particularly limited and may be determined appropriately. For example, a composition that will be described herein later may be molded (or shaped) (for example, via injection molding) or joined together to provide a molded article including an integrated bottom wall and a plurality of side walls. The container 1 has an open side 8 which is opposite to the bottom wall 2 and through which an electrode assembly is inserted into the container 1 in order to house the electrode assembly. A battery casing according to an embodiment may further include a lid 4 to cover (e.g., seal, close) at least a portion (e.g., the whole) of the open side of the container 1. For example, the lid may cover all of the open side of the container. The lid 4 may include the positive terminal 6a, the negative terminal 6a (e.g., positive terminal and negative terminal), or a combination thereof. The lid 4 may be formed of the same material as the container 1. Alternatively, the lid 4 may be formed from a different material than the container 1.

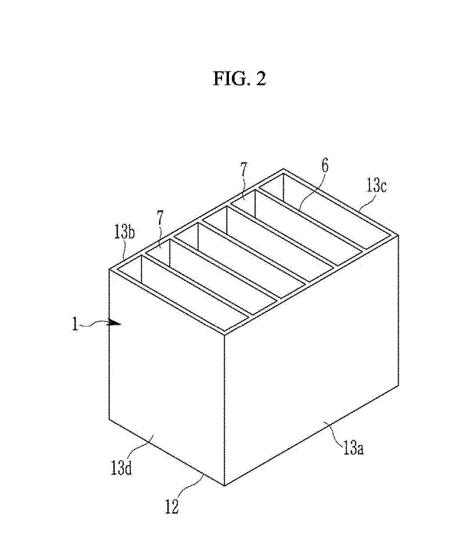

FIG. 2 is an exploded perspective view of a battery casing according to another embodiment. Referring to FIG. 2, the container 1 of the battery casing according to an embodiment includes side walls 13a, 13b, 13c, and 13d and a bottom wall 12 that are integrated with each other to define a space 8. In the space, at least one partition wall 6 may be disposed, and thereby the container may include a plurality of cell compartments 7. The number of partition walls may be 1, 2, 3, 4, 5, or greater, but is not limited thereto. The number of cell compartments may be 2 or more, for example, 3 or more, 4 or more, or 5 or more, and is determined by the number of partition walls. Each cell compartment may house an electrode assembly that will be described later.

The electrode assembly may be disposed in the space to manufacture a battery or a battery module. In order to provide the electrode assembly with an electrolyte solution, an electrolyte solution may be injected into the space after disposing the electrode assembly therein. The open side of the battery casing may be closed and sealed with the lid after disposing the electrode assembly.

FIGS. 1 and 2 show a rectangular parallelepiped battery casing, but the battery casing according to an embodiment is not limited thereto and may have various shapes and sizes and various number of containers.

There is a need for the development of a battery or a battery module having improved properties, for use in various types of mobile electronic device and various types of electric transportation means (EV, referred to as electric vehicle). For example, an electric vehicle may use a battery or a battery module in order to provide a portion of or all of a motive power. The battery or battery module of the embodiments described herein may include a rechargeable lithium battery capable of charging and discharging, and having a relatively high energy density. In case of the rechargeable lithium battery, moisture which has permeated through a battery exterior casing may cause the generation of hydrofluoric acid (HF), which may lead to serious deterioration of the electrode performance. Therefore, a battery module including the rechargeable lithium battery may have an aluminum-based material having a relatively high moisture transmission resistivity. For example, a battery module including the rechargeable lithium battery may be manufactured by inserting an electrode assembly including a positive electrode, a negative electrode, and a separator into a case of an aluminum pouch and aluminum can, sealing the same to manufacture a battery cell, and integrating a plurality of battery cells. This may involve a complicated assembly/manufacturing process that takes a long time and a high cost. It would be desirable to provide a plastic based battery casing having the requisite properties (e.g., improved mechanical properties and moisture transmission resistivity) and which may be used to seal at least one electrode assembly in the battery casing without the need to use an aluminum pouch/case. In addition, a metal based battery casing has a limit in terms of a shape/size and a plurality of process steps are needed in order to embody various shapes and/or sizes. The metal based battery casing is heavy and thus it is difficult to realize a light-weight battery (module) for housing a battery cell having a large size and/or a plurality of battery cells.

A battery casing according to an embodiment may not include a metal layer (e.g., aluminum layer), and has a significantly reduced weight compared with a battery casing including a metal material due to the use of a plastic material (e.g., polyethylene polymer). The battery casing also has improved mechanical properties and moisture transmission resistivity.

Therefore, in the battery casing according to an embodiment, at least one of the bottom wall and the plurality of side walls includes a composition including a base polymer and a plurality of rod-shaped nucleating agent particles dispersed in the base polymer. The base polymer may be a polyethylene polymer. The nucleating agent particle(s) may have an aspect ratio of greater than or equal to about 2, greater than or equal to about 3, greater than or equal to about 4, greater than or equal to about 5, or greater than or equal to about 6, as defined by a ratio of the length to the thickness thereof. An amount of the nucleating agent particles may be greater than or equal to about 0.01 parts by weight and less than or equal to about 3 parts by weight, greater than or equal to about 0.1 parts by weight and less than or equal to about 3 parts by weight, or greater than or equal to about 0.1 parts by weight and less than or equal to about 2 parts by weight, per 100 parts by weight of the base polymer.

Therefore, an embodiment provides a composition including the base polymer including the polyethylene polymer and the nucleating agent particles dispersed in the base polymer, and in the composition, the nucleating agent particles have a rod shape, the nucleating agent particles have an aspect ratio of greater than or equal to about 2 as determined by a ratio of the length to the thickness thereof, and the nucleating agent particles are included in an amount of greater than or equal to about 0.01 parts by weight and less than or equal to about 3 parts by weight.

The base polymer may comprise, consist essentially of, or consist of a polyethylene polymer. In an embodiment, the base polymer may further include a second polymer other than the polyethylene polymer. The second polymer may include, for example, a polyolefin other than the polyethylene polymer, such as a polypropylene polymer, polyester, a liquid crystal polymer, or a combination thereof.

The polyethylene polymer may include, for example, a linear polyethylene that may be prepared by using a transition metal catalyst. The polyethylene polymer may be a homopolymer of linear polyethylene. The polyethylene polymer may be a copolymer including linear polyethylene. The polyethylene may have density of greater than or equal to about 0.9 grams per cubic centimeter (g/cc). The polyethylene polymer may include high density polyethylene (HDPE), linear low density polyethylene (LLDPE), or a combination thereof. The high density polyethylene may be a linear polyethylene and may include a small amount of alpha olefin, for example, propylene, butene, pentene, hexene, heptene, octene, or a combination thereof. The high density polyethylene may have density of greater than or equal to about 0.93 g/cc, for example, greater than or equal to about 0.935 g/cc, greater than or equal to about 0.94 g/cc, or greater than or equal to about 0.95 g/cc. The high density polyethylene may have density of less than about 1 g/cc, for example, less than or equal to about 0.98 g/cc. The linear low density polyethylene (LLDPE) may have density of greater than or equal to about 0.9 g/cc and less than or equal to about 0.935 g/cc. The polyethylene polymer having the aforementioned properties may be synthesized using methods known to those of skill in the art, or may be commercially available (e.g., from Hanwha Total Petrochemical Co., Ltd.).

When the polyethylene polymer includes at least two types of polymers, a weight ratio therebetween may be selected by taking into consideration the crystallinity and mechanical properties (e.g., strength) of each of the polyethylene polymers.

A melt flow index (MFI) of the base polymer may be, for example, greater than or equal to about 0.01 g/10 min, greater than or equal to about 0.05 g/10 min, greater than or equal to about 0.1 g/10 min, greater than or equal to about 0.2 g/10 min, greater than or equal to about 0.3 g/10 min, greater than or equal to about 0.4 g/10 min, or greater than or equal to about 0.5 g/10 min, as measured at 190° C. under a load of 2.16 kilograms (kg) according to ASTM D 1238.

The melt flow index of the base polymer may be less than or equal to about 5 g/10 min, for example, less than or equal to about 4.5 g/10 min. When the base polymer includes at least two types of polymers, each polymer may exhibit a different melt flow index and an amount of each polymer may be controlled so that the melt flow index of the base polymer is within the aforementioned ranges.

The composition may include a nucleating agent particle, e.g., a plurality of nucleating agent particles, having a rod shape. As used herein, the term “nucleating agent” refers to an additive configured to change the crystallization behavior of a polymer during the cooling of a polymer melt. The polymer may be molded into an article via a melt process such as, for example, an extrusion molding process or an injection molding process. Semi-crystalline polymers such as polyethylene or polyester may form a crystal when being cooled following a melt process. The crystallization behavior of these polymers may have an effect on a crystallization rate, the size and/or dimension of the crystal domains, crystallinity, and the like, and thus may substantially affect the performance of a final product including a molded article. The linear polyethylene polymer (e.g., high density polyethylene) is a crystalline polymer having a linear molecular chain and thus a relatively high degree of crystallinity. Without wishing to be bound by any theory, it is believed that the crystallization properties of a melted polymer may substantially affect the mechanical properties and barrier performance of the produced molded article.

In the composition according to an embodiment, the nucleating agent particles may have an effect on a crystallization rate and dimensions of crystal domains during a crystallization process of the base polymer. For example, the nucleating agent particles may be present in a small amount in the composition, for example, less than or equal to about 3 weight percent (wt %), for example less than or equal to about 2 wt %, or less than or equal to about 1 wt % and greater than or equal to about 0.01 wt %, for example greater than or equal to about 0.05 wt %, or greater than or equal to about 0.1 wt %. By including the nucleating agent particles in the above-described amounts, a crystallization rate of the entire composition may be increased (e.g., isothermal crystallization of greater than or equal to about 120° C.) and thus a semi-crystallization time of the entire composition may be decreased by about 30% or greater, about 40% or greater, or about 50% or greater compared with a semi-crystallization time of a same composition but without the nucleating agent particles. In the composition according to an embodiment, an amount of the nucleating agent particles may be greater than or equal to about 0.01 parts by weight, for example, greater than or equal to about 0.04 parts by weight, greater than or equal to about 0.05 parts by weight, greater than or equal to about 0.06 parts by weight, greater than or equal to about 0.07 parts by weight, greater than or equal to about 0.08 parts by weight, greater than or equal to about 0.09 parts by weight, greater than or equal to about 0.1 parts by weight, greater than or equal to about 0.15 parts by weight, greater than or equal to about 0.2 parts by weight, greater than or equal to about 0.25 parts by weight, greater than or equal to about 0.3 parts by weight, greater than or equal to about 0.35 parts by weight, greater than or equal to about 0.4 parts by weight, or greater than or equal to about 0.45 parts by weight, based on 100 parts by weight of the base polymer. In the composition according to an embodiment, the amount of the nucleating agent particles may be less than or equal to about 3 parts by weight, for example less than or equal to about 2.5 parts by weight, less than or equal to about 2.0 parts by weight, less than or equal to about 1.9 parts by weight, less than or equal to about 1.8 parts by weight, less than or equal to about 1.7 parts by weight, less than or equal to about 1.6 parts by weight, less than or equal to about 1.5 parts by weight, less than or equal to about 1.4 parts by weight, less than or equal to about 1.3 parts by weight, less than or equal to about 1.2 parts by weight, less than or equal to about 1.1 parts by weight, less than or equal to about or 1.0 part by weight, based on 100 parts by weight of the base polymer.

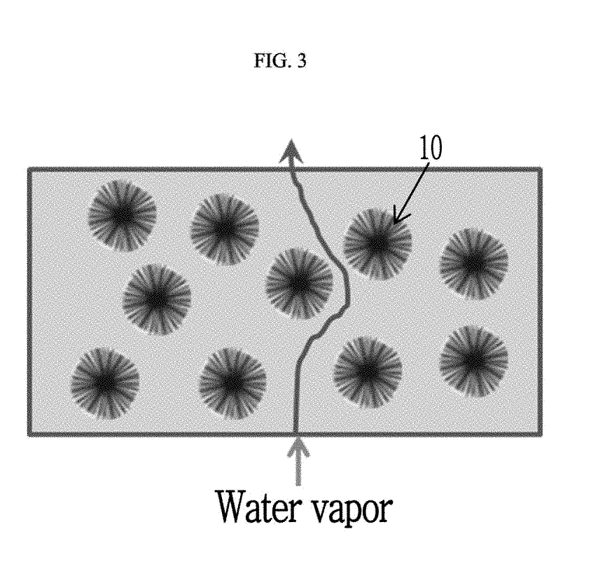

A base polymer including a polyethylene polymer alone, that is, without the nucleating agent particles, may make it difficult to prepare an article which exhibits a barrier performance requisite for an integrated type casing of a lithium battery. However, the addition of a filler such as a nucleating agent particle to a polymer composition may cause a substantial decrease in the impact strength of a molded article prepared therefrom. The composition according to an embodiment solves the aforementioned drawbacks and may provide a molded article having improved barrier performance without substantially degrading the mechanical properties (e.g., impact strength) of the molded article by the inclusion of the rod-shaped nucleating agent particle. Without wishing to be bound by any theory, the composition may exhibit improved properties for at least the following reasons, with reference to FIGS. 3-5.

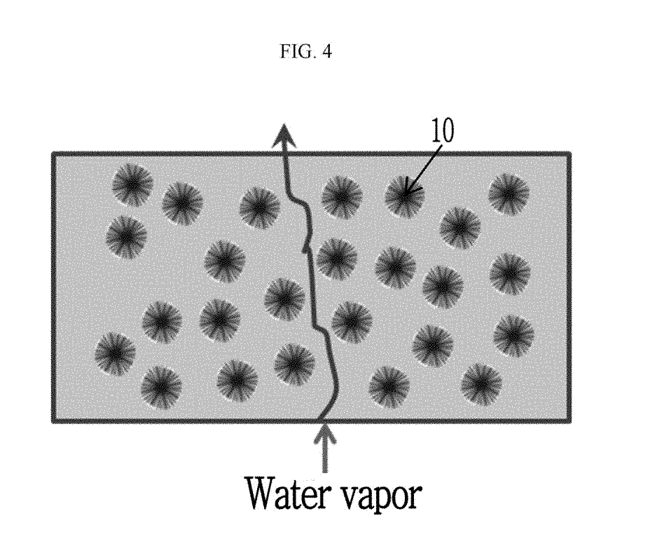

The polyethylene polymer (e.g., linear polyethylene polymer) may form a spherical polymer crystal 10 by a lamellar growth based on a chain folding of the polymer (see FIGS. 3 and 4). Without wishing to be bound by any theory, it is understood that in the presence of the nucleating agent particle (FIG. 4), the polymer chain grows while it maintains a chain-axis arrangement in a direction parallel to the surface of the nucleating agent particle, and thereby crystals having a reduced size may be formed in a greater number than the case where the nucleating agent is not used.

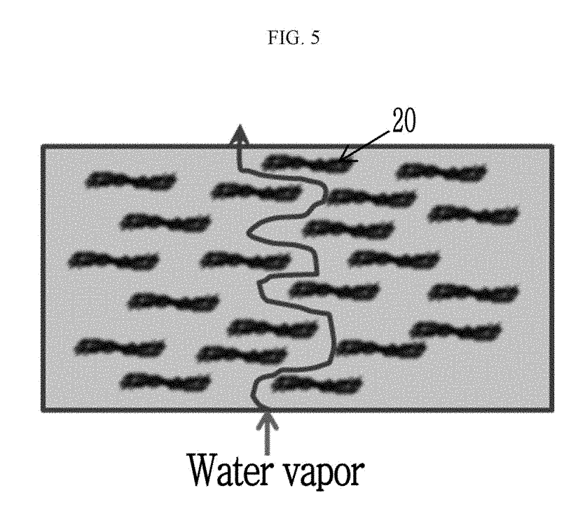

When the aspect ratio of the nucleating agent particle is controlled in order for the particle to have a rod shape, polymer crystals may be lamella grown to form a greater number of plate-shaped polymer crystals 20, and the plate-shaped polymer crystal region thus formed may increase the length of the transmission path of water vapor while it blocks the water, thereby improving moisture transmission resistivity. (See FIG. 5)

Meanwhile, the present inventors also have discovered that although a plate like nanoclay or graphite may improve moisture transmission resistivity slightly, the plate like nanoclay or graphite may also cause a sharp decrease in the mechanical properties, in particular, the impact strength. For example, a composite including the plate shaped nucleating agent may have an impact strength that is decreased to 50% or less of the impact strength of a composition not including the nucleating agent. Thus, when these materials (plate like nanoclay or graphite) are included as a nucleating agent, improvement of impact strength and moisture transmission resistivity at the same time cannot be ensured.

In an embodiment, an average aspect ratio of the nucleating agent particles having a rod shape may be greater than or equal to about 3, greater than or equal to about 3.5, greater than or equal to about 4, greater than or equal to about 4.5, greater than or equal to about 5, greater than or equal to about 5.5, or greater than or equal to about 6. The average aspect ratio of the nucleating agent particles may be less than or equal to about 20, less than or equal to about 18, less than or equal to about 16, less than or equal to about 15, less than or equal to about 14, less than or equal to about 13, less than or equal to about 12, less than or equal to about 11, or less than or equal to about 10. The average of the lengths of the nucleating agent particles may be greater than or equal to about 0.5 micrometer (μm), greater than or equal to about 1 μm, or greater than or equal to about 1.5 μm. The average of the lengths of the nucleating agent particles may be less than or equal to about 20 μm, for example, less than or equal to about 19 μm, less than or equal to about 18 μm, less than or equal to about 17 μm, less than or equal to about 16 μm, less than or equal to about 15 μm, less than or equal to about 14 μm, less than or equal to about 13 μm, less than or equal to about 12 μm, less than or equal to about 11 μm, or less than or equal to about 10 μm.

At least a portion of the nucleating agent particles may have a circular or polygonal (triangular, quadrangular, pentagonal, hexagonal, etc.) cross-section. As used herein, a particle cross-section refers to a cross-section substantially vertical to the length (L). In an embodiment, the nucleating agent particles may not have a sheet or plate shape. Therefore, the nucleating agent particles may have a ratio of the circumference of the particle cross-section to the thickness of the particle of greater than or equal to about 2, greater than or equal to about 3, or greater than or equal to about 4 and less than or equal to about 20, less than or equal to about 19, less than or equal to about 18, less than or equal to about 17, less than or equal to about 16, less than or equal to about 15, less than or equal to about 14, less than or equal to about 13, less than or equal to about 12, less than or equal to about 11, less than or equal to about 10, less than or equal to about 9, less than or equal to about 8, less than or equal to about 7, less than or equal to about 6, or less than or equal to about 5. For example, the nucleating agent particles may have an average ratio of the circumference of the particle cross-section to the thickness of the particle of less than or equal to about 12, less than or equal to about 11, less than or equal to about 10, less than or equal to about 9, less than or equal to about 8, less than or equal to about 7, less than or equal to about 6, or less than or equal to about 5.

The nucleating agent particles may include an organic compound, an inorganic compound, or a combination thereof. The organic compound may include a metal salt of a cyclic organic acid. The metal salt may be an alkaline metal or an alkaline-earth metal salt. Examples of the cyclic organic acid may include hydrogenated phthalic acid, bicycloalkene, cyclohexane dicarboxylic acid, or a combination thereof. In an embodiment, the nucleating agent particles may include a metal salt (e.g., an alkaline metal salt such as Na, K, or Li, or an alkaline-earth metal salt such as Mg, Ca, or Ba) having a hexahydrophthalate moiety, a phosphate metal salt (e.g., an alkaline metal salt such as Na, K, or Li, or an alkaline-earth metal salt such as Mg, Ca, or Ba), a titanium-potassium-niobium composite oxide, or a combination thereof. In an embodiment, the nucleating agent particles do not include a surface treatment including an organic compound. For example, the nucleating agent particles may not be surface-treated with other organic compounds which differ from the organic compound constituting the particles.

At least one of the bottom wall and the plurality of side walls may include the composition and may be a molded article of the composition. Therefore, another embodiment provides a molded article including a base polymer including a polyethylene polymer, wherein the plurality of the nucleating agent particles are dispersed in the base polymer. A method of producing the molded article is not particularly limited but may be selected appropriately. The molded article may be produced by obtaining a pellet including the composition and molding the same in a desirable shape through an extrusion molding machine or an injection molding machine. The type of the extrusion molding machine and/or the injection molding machine are not particularly limited. This extrusion molding machine or injection molding machine may be commercially available.

As described above, a casing for a cell-module integrated lithium battery benefits from improved strength and low moisture transmission. The casing having a plurality of side walls and/or a bottom wall including the composition, or molded article thereof, according to an embodiment, may exhibit enhanced moisture transmission resistivity while maintaining improved impact strength.

Therefore, in a battery casing according to an embodiment, a molded article produced from the composition may have a crystallinity of greater than or equal to about 71% as measured by a differential scanning calorimeter (DSC). The molded article may have a tensile strength, measured at a tensile speed of 50 millimeters per minute (mm/min), as measured according to ASTM D638 of greater than or equal to about 250 kilogram force per square centimeter (kgf/cm²), for example, greater than or equal to about 260 kgf/cm², greater than or equal to about 270 kgf/cm², greater than or equal to about 280 kgf/cm², greater than or equal to about 290 kgf/cm², greater than or equal to about 300 kgf/cm², greater than or equal to about 310 kgf/cm², greater than or equal to about 320 kgf/cm², greater than or equal to about 330 kgf/cm², greater than or equal to about 340 kgf/cm², greater than or equal to about 350 kgf/cm², greater than or equal to about 360 kgf/cm², greater than or equal to about 370 kgf/cm², greater than or equal to about 380 kgf/cm², greater than or equal to about 390 kgf/cm², greater than or equal to about 400 kgf/cm², greater than or equal to about 410 kgf/cm², greater than or equal to about 420 kgf/cm², or greater than or equal to about or 430 kgf/cm².

The molded article may have a notched Izod impact strength, as measured according to ASTM D265, of greater than or equal to about 30 kilojoules per square meter (kJ/m²), greater than or equal to about 31 kJ/m², greater than or equal to about 32 kJ/m², greater than or equal to about 33 kJ/m², greater than or equal to about 34 kJ/m², greater than or equal to about 35 kJ/m², greater than or equal to about 36 kJ/m², greater than or equal to about 37 kJ/m², or greater than or equal to about 38 kJ/m².

The molded article may have a water vapor transmittance rate (WVTR) of less than or equal to about 0.5 grams per square meter per day (g/m² day), for example 0.49 g/m² day, less than or equal to about 0.48 g/m² day, less than or equal to about 0.47 g/m² day, less than or equal to about 0.46 g/m² day, less than or equal to about 0.45 g/m² day, less than or equal to about 0.44 g/m² day, less than or equal to about 0.43 g/m² day, less than or equal to about 0.42 g/m² day, less than or equal to about 0.41 g/m² day, less than or equal to about 0.40 g/m² day, less than or equal to about 0.39 g/m² day, less than or equal to about 0.38 g/m² day, less than or equal to about 0.37 g/m² day, less than or equal to about 0.36 g/m² day, less than or equal to about 0.35 g/m² day, less than or equal to about 0.34 g/m² day, less than or equal to about 0.33 g/m² day, less than or equal to about 0.32 g/m² day, less than or equal to about 0.31 g/m² day, less than or equal to about 0.30 g/m² day, less than or equal to about 0.29 g/m² day, less than or equal to about 0.28 g/m² day, less than or equal to about 0.27 g/m² day, less than or equal to about 0.26 g/m² day, less than or equal to about 0.25 g/m² day, or less than or equal to about 0.24 g/m² day, as measured at 38° C. and a relative humidity of 100% according to ISO 15106 and ASTM F1249.

In another embodiment, a battery (or a battery module, hereinafter, also referred to as a battery) includes the battery casing. The battery or battery module includes at least one electrode assembly housed in the container of the battery casing. The battery casing is the same as described above. The electrode assembly includes a positive electrode, a negative electrode, and a separator disposed therebetween. The electrode assembly may further include, for example, an aqueous or non-aqueous electrolyte solution in the separator. The type of the electrode assembly is not particularly limited. In an embodiment, the electrode assembly may include an electrode assembly for a rechargeable lithium battery. The positive electrode, the negative electrode, the separator, and the electrolyte solution of the electrode assembly may be selected appropriately according to the desired type of the electrode and are not particularly limited. Hereinafter, an electrode assembly for a rechargeable lithium battery is exemplified but the present disclosure is not limited thereto.

The positive electrode may include, for example, a positive active material disposed on a positive current collector and may further include a conductive material, a binder, or a combination thereof. The positive electrode may further include a filler. The negative electrode may include, for example a negative active material disposed on a negative current collector and may further include a conductive material, a binder, or a combination thereof. The negative electrode may further include a filler.

The positive active material may include, for example an oxide including lithium (solid solution) but is not particularly limited as long as it is a material capable of incorporating and deincorporating lithium ions electrochemically. The positive active material may be a layered compound such as lithium cobalt oxide (LiCoO₂), lithium nickel oxide (LiNiO₂), and the like, a compound substituted with one or more transition metal; a lithium manganese oxide such as chemical formula Li₁₊ₓMn₂₋ₓO₄ (wherein, x is 0 to 0.33), LiMnO₃, LiMn₂O₃, LiMnO₂, or a combination thereof; lithium copper oxide (Li₂CuO₂), vanadium oxide such as LiV₃O₈, LiFe₃O₄, V₂O₅, Cu₂V₂O₇, or a combination thereof; a Ni site-type lithium nickel oxide represented by chemical formula LiNi₁₋ₓMxO₂ (wherein, M includes Co, Mn, Al, Cu, Fe, Mg, B, Ga, or a combination thereof, and x is 0.01 to 0.3); a lithium manganese composite oxide represented by chemical formula LiMn₂₋ₓMₓO₂ (wherein, M includes Co, Ni, Fe, Cr, Zn, Ta, or a combination thereof, and x is 0.01 to 0.1) or Li₂Mn₃MO₈ (wherein, M includes Fe, Co, Ni, Cu, Zn, or a combination thereof); LiMn₂O₄ where a portion of the Li may be substituted with an alkaline-earth metal ion; a disulfide compound; Fe₂(MoO₄)₃, but is not limited thereto. A combination comprising at least one of the foregoing may also be used.

Examples of the conductive material may include carbon black such as ketjen black, acetylene black, natural graphite, artificial graphite, or a combination thereof, but is not particularly limited as long as it may increase conductivity of the positive electrode.

The binder may include for example, polyvinylidene fluoride, ethylene-propylene-diene terpolymer, styrene-butadiene rubber, acrylonitrile-butadiene rubber, a fluorine rubber, polyvinylacetate, polymethylmethacrylate, polyethylene, nitrocellulose, or a combination thereof, but is not particularly limited as long as the material may bind together the positive or negative active material and the conductive material on the current collector. Additional examples of the binder may include polyvinyl alcohol, carboxymethyl cellulose (CMC), starch, hydroxypropyl cellulose, recycled cellulose, tetrafluoroethylene, polyethylene, polypropylene, an ethylene-propylene-diene polymer (EPDM), sulfonated EPDM, a styrene butylene rubber, a fluorine rubber, various copolymers, polymeric highly saponified polyvinyl alcohol, or a combination thereof, either alone or in addition to the foregoing materials.

The negative active material may include for example, carbon and graphite materials such as natural graphite, artificial graphite, expanded graphite, carbon fiber, non-graphitizable carbon, carbon black, carbon nanotube, fullerene, activated carbon; a metal such as Al, Si, Sn, Ag, Bi, Mg, Zn, In, Ge, Pb, Pd, Pt, Ti, an alloy thereof with lithium, a compound thereof; a composite material of a metal and a compound thereof, and a carbon and graphite material; a lithium-containing nitride; or a combination thereof. Among them, carbon-based active materials, silicon-based active materials, tin-based active materials, or silicon-carbon-based active materials may be desirably used and may be used alone or in a combination of two or more.

The separator is not particularly limited and may be any separator suitable for a rechargeable lithium battery. For example, a porous film or non-woven fabric having excellent high rate, discharge performance may be used alone or in a combination thereof. The separator may include pores and the pores may have a pore diameter of about 0.01 to about 10 μm and a thickness of about 5 to about 300 μm. A substrate of the separator may include, for example, a polyolefin-based resin, a polyester-based resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, or a combination thereof. When the electrolyte is a solid electrolyte such as a polymer, the solid electrolyte may function as a separator.

The conductive material is a component which further improves the electrical conductivity of an active material and may be included in an amount of about 1 wt % to about 30 wt % based on a total weight of the electrode, but is not limited thereto. Such a conductive material is not particularly limited as long as it does not cause a chemical change within a battery and has electrical conductivity. The conductive material may be for example, graphite such as natural graphite or artificial graphite; carbon black such as carbon black, acetylene black, ketjen black, channel black, furnace black, lamp black, summer black, and the like; a carbon derivative such as carbon nanotube, fullerene, and the like, a conductive fiber such as a carbon fiber or a metal fiber, and the like; carbon fluoride; a metal powder such as fluorocarbon, aluminum, a nickel powder, and the like; a conductive whisker such as zinc oxide, potassium titanate, and the like; a conductive metal oxide such as a titanium oxide; a conductive polymer such as a polyphenylene derivative, and the like. A combination comprising at least one of the foregoing conductive materials may also be used.

The filler is an auxiliary component which may be used to suppress the expansion of an electrode. The filler is not particularly limited as long as it does not cause a chemical change in a battery and is a fibrous material. The filler may be for example, an olefin-based polymer such as polyethylene, polypropylene, and the like; a fiber-shaped material such as a glass fiber, a carbon fiber, and the like. A combination comprising at least one of the foregoing fillers may also be used

In the electrode, the current collector may be a site to where electrons are transported in an electrochemical reaction of the active material and may be a negative current collector or a positive current collector depending upon the type of the electrode. The negative current collector may have a thickness of about 3 μm to about 500 μm. The negative current collector is not particularly limited as long as it does not cause a chemical change in a battery and has electrical conductivity. The negative current collector may be include for example, copper, stainless steel, aluminum, nickel, titanium, fired carbon, copper or stainless steel that is surface-treated with carbon, nickel, titanium, and/or silver, an aluminum-cadmium alloy, or a combination thereof.

The positive current collector may have a thickness of about 3 μm to about 500 μm, but is not limited thereto. Such a positive current collector is not particularly limited as long as it does not cause a chemical change in a battery and has high electrical conductivity. The positive current collector may include, for example, stainless steel, aluminum, nickel, titanium, fired carbon, or aluminum or stainless steel that is surface-treated with carbon, nickel, titanium, and/or silver, or a combination thereof.

The current collector (negative or positive) may have a fine concavo-convex shape on its surface to reinforce binding between the current collector and the active material, and may have various shapes such as, for example, a film, a sheet, a foil, a net, a porous film, a foam, a non-woven fabric, or the like.

The lithium-containing non-aqueous electrolyte solution may comprise, consist essentially of, or consist of a non-aqueous electrolyte and a lithium salt.

The non-aqueous electrolyte may include, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like.

The lithium salt is dissolved in the non-aqueous electrolyte solution and examples thereof may include, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, LiBCl₄, chloroborane lithium, a C1-C10 aliphatic lithium carbonate, lithium tetrakis(pentafluorophenyl)borate, lithium imide, lithium tetraphenyl borate, and the like.

An organic solid electrolyte, an inorganic solid electrolyte, and the like may be used as needed.

The organic solid electrolyte may be, for example, polyethylene derivative, a polyethylene oxide derivative, a polypropylene oxide derivative, a phosphoric acid ester polymer, a poly-l-lysine, polyester sulfide, polyvinyl alcohol, polyvinylidene fluoride, a polymer including an ionic leaving group, and the like.

The inorganic solid electrolyte may be, for example, a nitride of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄-Li₂S—SiS₂, a lithium halide, a lithium sulfate, or a combination thereof.

The non-aqueous electrolyte solution may include, for example, pyridine, triethylphosphite, triethanolamine, a cyclic ether, ethylene diamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, aluminum trichloride, or a combination thereof, in order to improve charge and discharge characteristics, flame retardancy, and the like. As desired, in order to provide flame retardancy, a halogen-containing solvent such as carbon tetrachloride, ethylene trifluoride, and the like, may be further added. In order to improve high temperature storage characteristics, carbon dioxide gas may be further added.

The composition according to an embodiment exhibits improved properties (e.g., high moisture transmission resistivity) as compared to a conventional resin for injection molding, and therefore the external assembly of unit cells may be omitted during manufacture of a cell/module integrated battery. Therefore, the (cell/module integrated) battery according to an embodiment may have reduced components and may be manufactured by a simplified process. In an embodiment, a battery (or a battery module) including the battery casing may be manufactured by a simplified manner. For example, a battery/battery module including the aforementioned battery casing (hereinafter, also referred to as an electrode assembly container) may be manufactured by molding the aforementioned composition to prepare the battery casing including, for example, at least two spaces for housing an electrode assembly, housing the electrode assembly in the electrode assembly container, and injecting an electrolyte solution in the electrode assembly container including the electrode assembly. The composition may be molded by any suitable molding machine and by any suitable molding method.

Hereinafter, specific examples are illustrated. However, these examples are exemplary, and the present disclosure is not limited thereto.

### Measuring Method

[1] Scanning Electron Microscope

A scanning electron microscope analysis is performed using Field emission-scanning electron microscope (FE-SEM; SU8030, Hitachi, Ltd.).

[2] Water vapor transmittance rate (WVTR): WVTR is measured using an Aquatran® (Mocon Inc.) at 38° C. and a relative humidity of 100%, according to ISO 15106, F1249.

[3] Tensile strength: Tensile strength is measured using a universal testing machine (QC-506BA, Cometech), according to ASTM D638 at a tensile speed of 50 mm/min.

[4] Impact strength: Notched type Izod Impact strength is measured using Pendulum impact tester (CEAST9050, Instron Corporation) according to ASTM D265.

### EXAMPLES

### Examples 1-1 to 1-3

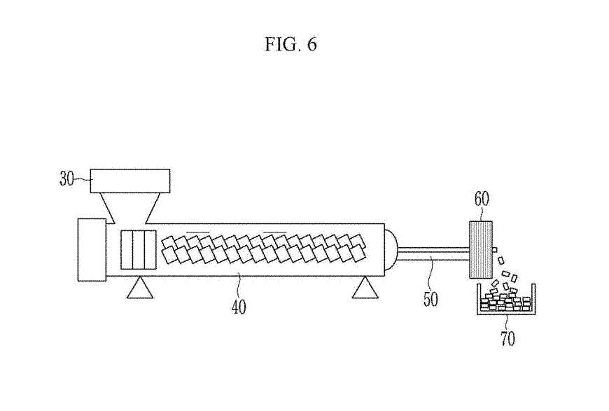

High density polyethylene (HDPE, tradename: B230A, manufacturer: Hanwha Total Petrochemical Co., Ltd.) and a hexahydrophthalate calcium salt particles having rod shape as a nucleating agent (tradename: HPN-20E, manufacturer: Milliken) are premixed in the amounts shown in Table 1. The mixture is placed in the hopper 30 of a twin-screw extruder 40 in the manner illustrated in the schematic view of FIG. 6 and passes through the extruder 40 at 240° C. at 60 rpm to melt-extrude the same. The resultant polymer stream 50 passes through a pelletizer 60 and is cut to obtain a polymer pellet 70.

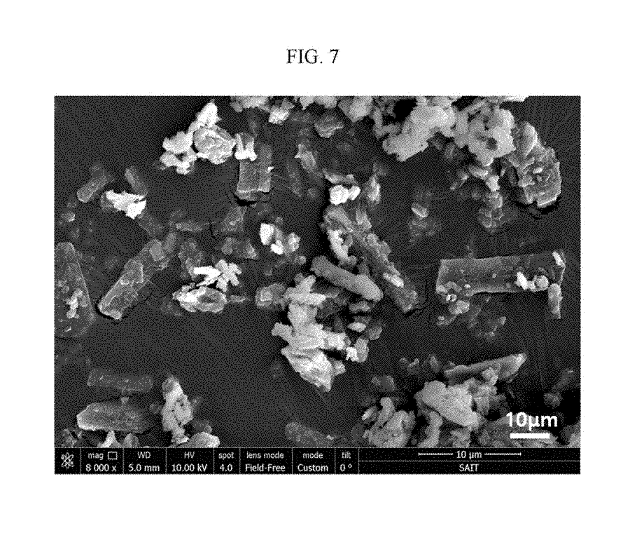

A scanning electron microscopic image of the nucleating agent particles dispersed in the HDPE is shown in FIG. 7.

A semi-crystallization time and crystallinity of the produced pellet (amount of nucleating agent: 0.1 wt %) are measured through an isothermal scan using a DSC and the results are shown in Table 2. Specimens are manufactured using an injection molding machine (model name: Minijet, HAAKE), WVTR, tensile strength, and impact strength of injection-molded specimens are measured, and the results are shown in Table 2.

### Examples 2-1 to 2-3

Polymer pellets are produced according to the same method as Example 1-1, except that calcium phosphate (tradename: calcium phosphate, manufacturer: Sigma-Aldrich) having a rod shape, as a nucleating agent, is used instead of the hexahydrophthalate calcium salt particle having a rod shape.

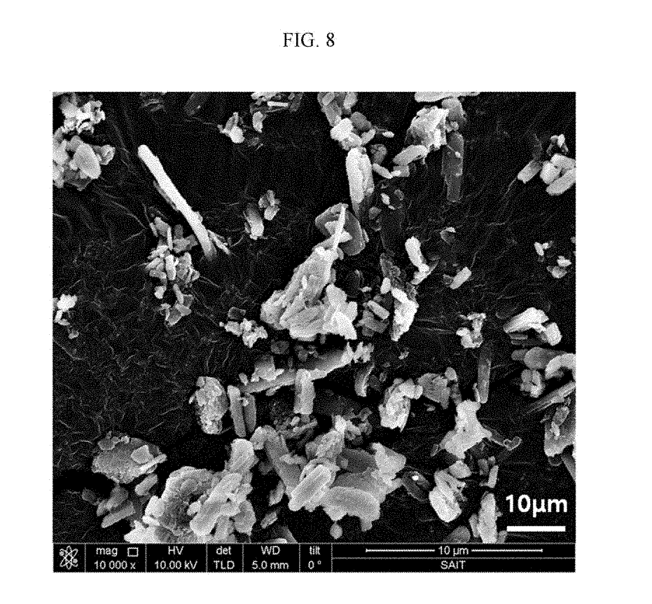

A scanning electron microscopic image of the nucleating agent particles is shown in FIG. 8.

A semi-crystallization time and crystallinity of the produced pellet (amount of nucleating agent: 0.5 wt %) are measured through an isothermal scan using a DSC and the results are shown in Table 2. Specimens are manufactured using an injection molding machine, WVTR, tensile strength, and impact strength of injection-molded specimens are measured, and the results are shown in Table 2.

### Examples 3-1 to 3-3

K₂CO₃, NbO₆, and TiO₂ are mixed at a predetermined ratio, and the mixture is fired at 1,000° C. for 12 hours to synthesize K₃Ti₅NbO₁₄ particles having a rod shape.

Polymer pellets are produced according to the same method as Example 1-1, except that K₃Ti₅NbO₁₄ is used instead of the hexahydrophthalate calcium salt particle having rod shape.

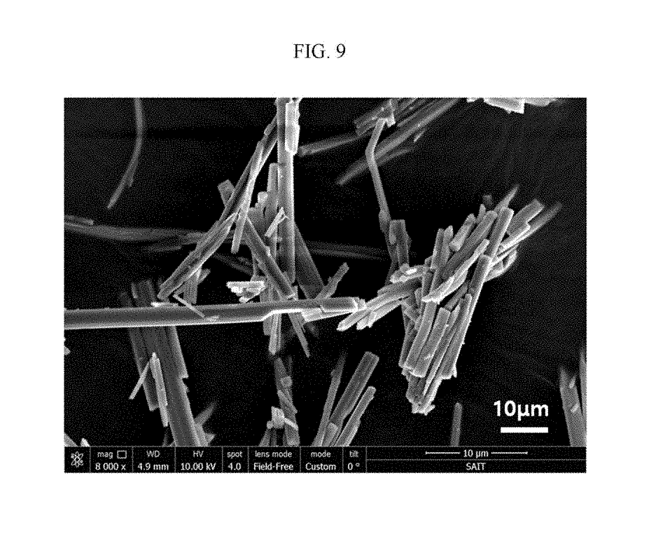

A scanning electron microscopic image of the nucleating agent particles is shown in FIG. 9.

A semi-crystallization time and crystallinity of the produced pellet (amount of nucleating agent: 0.5 wt %) are measured through an isothermal scan using a DSC and the results are shown in Table 2. Specimens are manufactured using an injection molding machine, WVTR, tensile strength, and impact strength of injection-molded specimens are measured, and the results are shown in Table 2.

### Comparative Example 1

Polymer pellets are produced according to the same method as Example 1-1, except that the nucleating agent is not used. A semi-crystallization time and crystallinity of the produced pellet are measured through an isothermal scan using a DSC and the results are shown in Table 2. Specimens are manufactured using an injection molding machine, WVTR, tensile strength, and impact strength of injection-molded specimens are measured, and the results are shown in Table 2.

### Comparative Example 2 and Comparative Example 3

Polymer pellets are produced according to the same method as Example 1-1, except that particles consisting of talc (tradename: Jetfine3CA, manufacturer: Imerys) (Comparative Example 2) or mica (tradename: M-150, manufacturer: KOCH) (Comparative Example 3) and having a plate shape are used in each amount of Table 1, as a nucleating agent instead of the hexahydrophthalate calcium salt particle having rod shape.

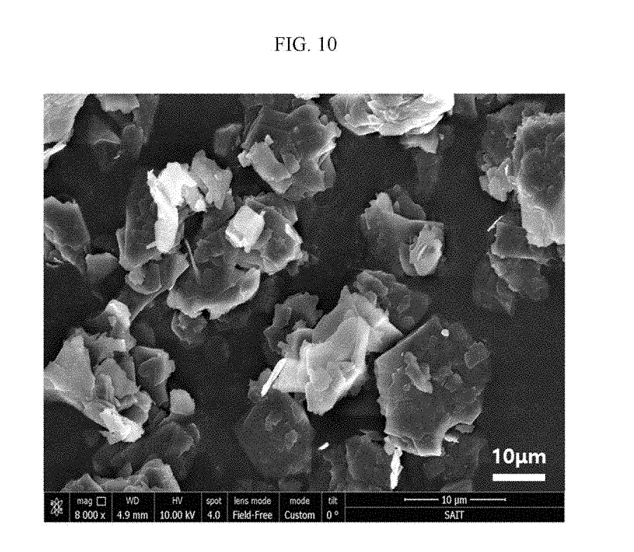

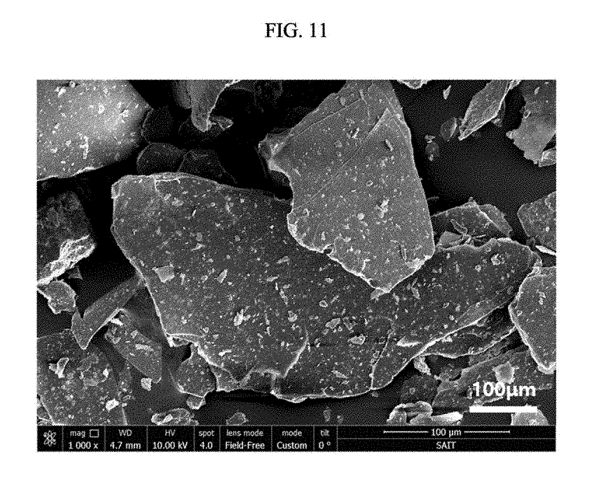

Scanning electron microscope images of the nucleating agent particles are shown in FIG. 10 (Comparative Example 2) and FIG. 11 (Comparative Example 3), respectively.

A semi-crystallization time and crystallinity of the produced pellet (amount of nucleating agent: 0.5 wt %) are measured through an isothermal scan using a DSC and the results are shown in Table 2. Specimens are manufactured using an injection molding machine, WVTR, tensile strength, and impact strength of injection-molded specimens are measured, and the results are shown in Table 2.

### Comparative Examples 4 to 6

Polymer pellets are produced according to the same method as Example 1-1, except that particles consisting of OM-POSS (octamethyl polyhedral oligomeric silsesquioxane, tradename: Octamethyl POSS, manufacturer: Hybrid Plastics) (Comparative Example 4), CaCO₃ (manufactured by Junsei, Comparative Example 5), or CaCO₃ (manufactured by Ditto, Comparative Example 6) and having a square shape are used in each amount of Table 1, as a nucleating agent instead of the hexahydrophthalate calcium salt particle having rod shape.

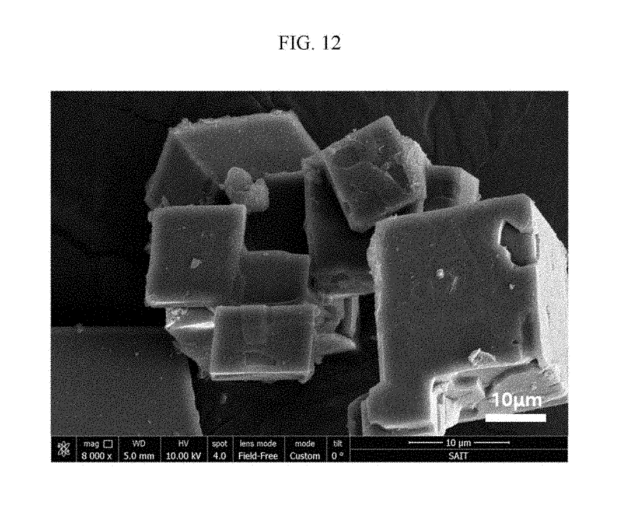

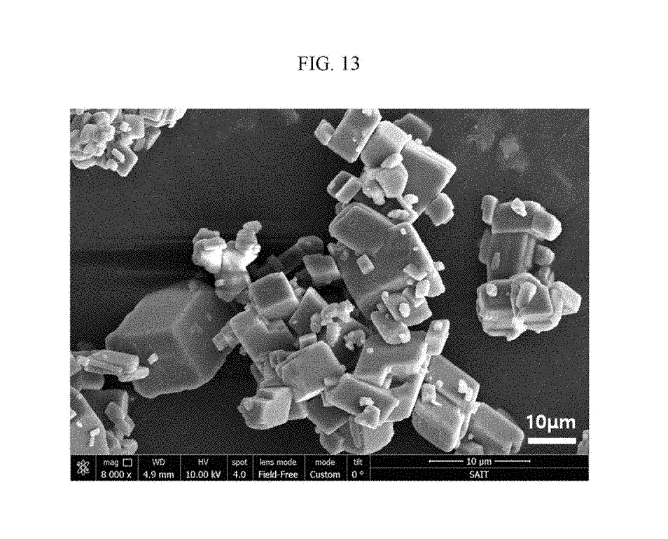

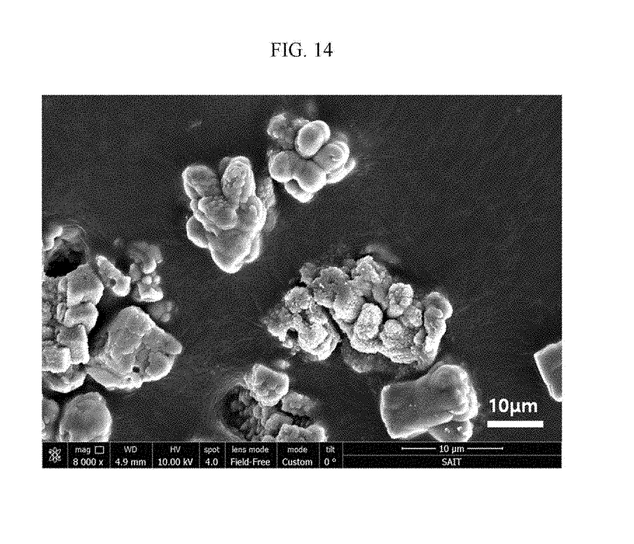

Scanning electron microscope images of the nucleating agent particles are shown in FIG. 12 (Comparative Example 4), FIG. 13 (Comparative Example 5), and FIG. 14 (Comparative Example 6), respectively.

A semi-crystallization time and crystallinity of the produced pellet (amount of nucleating agent: 0.5 wt %) are measured through an isothermal scan using a DSC and the results are shown in Table 2. Specimens are manufactured using an injection molding machine, WVTR of injection-molded specimens are measured, and the results are shown in Table 2.

### Comparative Examples 7 to 10

Polymer pellets are produced according to the same method as Example 1-1, except that particles consisting of BaSO₄ (tradename: Barium sulfate, manufacturer: Sigma-Aldrich) (Comparative Example 7), TiO₂ (tradename: Titanium oxide, manufacturer: Sigma-Aldrich) (Comparative Example 8), or SiO₂ (tradename: SG-SO800, SG-SO100, manufacturer: Sukgyung) (Comparative Example 9 and Comparative Example 10) and having a bead shape are used in the amount shown in Table 1 as a nucleating agent, instead of the hexahydrophthalate calcium salt particle having rod shape.

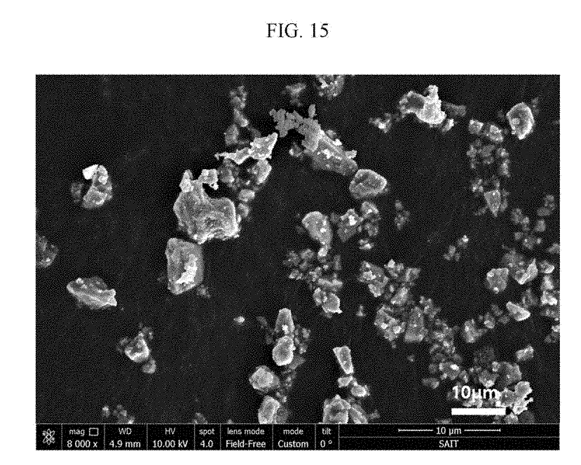

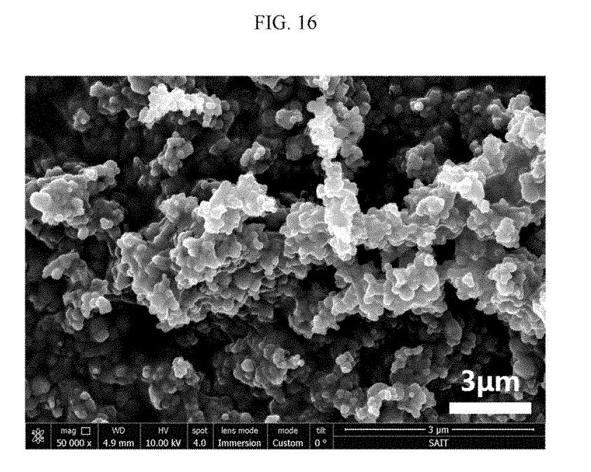

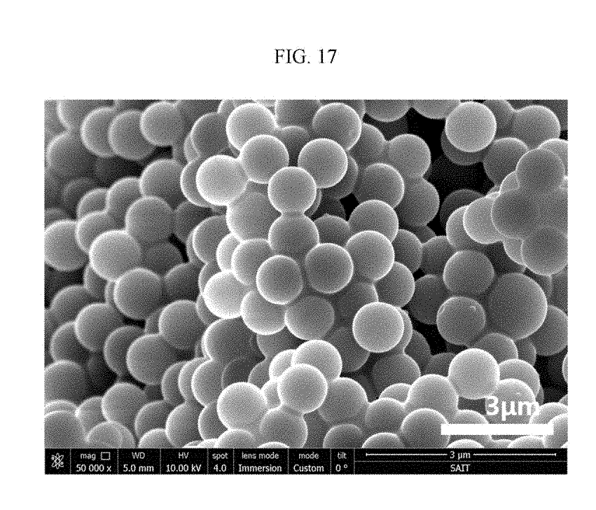

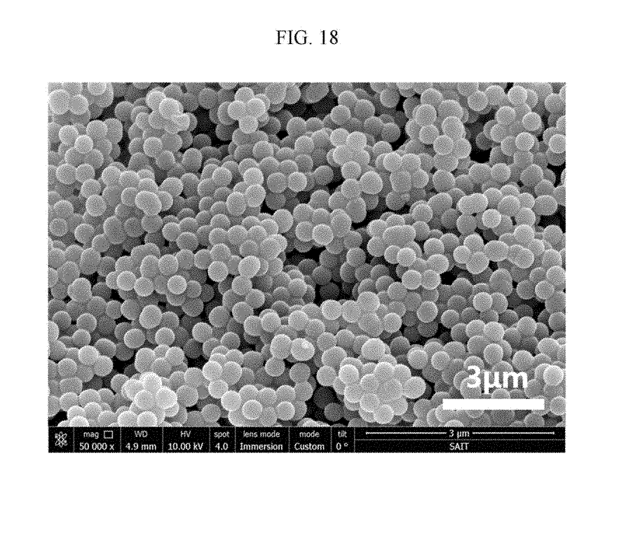

Scanning electron microscope images of the nucleating agent particles are shown in FIG. 15 (Comparative Example 7), FIG. 16 (Comparative Example 8), and FIGS. 17 and 18 (Comparative Examples 9 and 10), respectively.

A semi-crystallization time and crystallinity of the produced pellet (amount of nucleating agent: 0.5 wt %) are measured through an isothermal scan using a DSC and the results are shown in Table 2. Specimens are manufactured using an injection molding machine, WVTR of injection-molded specimens are measured, and the results are shown in Table 2.

TABLE 1

| | HDPE | Nucleating agent | | | |
|---|---|---|---|---|---|
| | amount | | | Aspect | Amount |
| | (%) | Shape | Size* (μm) | ratio** | (%) |
| Example 1-1 | 99.9 | Rod | 5 | 10 | 0.1 |
| Example 1-2 | 99.5 | | | | 0.5 |
| Example 1-3 | 97.0 | | | | 3.0 |
| Example 2-1 | 99.5 | Rod | 2 | 6 | 0.5 |
| Example 2-2 | 99.0 | | | | 1.0 |
| Example 2-3 | 97.0 | | | | 3.0 |
| Example 3-1 | 99.5 | Rod | 8 | 10 | 0.5 |
| Example 3-2 | 99.0 | | | | 1.0 |
| Example 3-3 | 97.0 | | | | 3.0 |
| Comparative | 100 | — | — | — | 0 |
| Example 1 | | | | | |
| Comparative | 99.5 | Plate | 7 | 22 | 0.5 |
| Example 2 | | | | | |
| Comparative | 99.5 | plate | 30 | 13 | 0.5 |
| Example 3 | | | | | |
| Comparative | 99.5 | Cubic | 10 | 1 | 0.5 |
| Example 4 | | | | | |
| Comparative | 99.5 | cubic | 5 | 1 | 0.5 |
| Example 5 | | | | | |
| Comparative | 99.5 | Cubic | 0.5 | 1 | 0.5 |
| Example 6 | | | | | |
| Comparative | 99.5 | Bead | 3 | 1 | 0.5 |
| Example 7 | | | | | |
| Comparative | 99.5 | Bead | 0.05 | 1 | 0.5 |
| Example 8 | | | | | |
| Comparative | 99.5 | Bead | 0.8 | 1 | 0.5 |
| Example 9 | | | | | |
| Comparative | 99.5 | Bead | 0.1 | 1 | 0.5 |
| Example 10 | | | | | |

In Table 1, the size is an average value of the largest length of the particle. In Table 1, the aspect ratio is an average value of largest length (L)/thickness (T) of the particle.

TABLE 2

| | | | | Strength | |
|---|---|---|---|---|---|
| | | DSC | | Tensile | Impact |
| | WVTR | | Crystallinity | strength | strength |
| | (g/m²day) | T_{1/2} (min) | (%) | (kgf/cm²) | (kJ/m²) |
| Example 1-1 | 0.2 | 0.729 | 72 | 355 | 41 |
| Example 1-2 | 0.28 | | | 356 | 40 |
| Example 1-3 | 0.5 | | | 359 | 38 |
| Example 2-1 | 0.19 | 1.1 | 72 | 430 | 40 |
| Example 2-2 | 0.23 | | | 430 | 39 |
| Example 2-3 | 0.45 | | | 431 | 35 |
| Example 3-1 | 0.3 | 0.958 | 71.8 | 451 | 40 |
| Example 3-2 | 0.3 | | | 450 | 36 |
| Example 3-3 | 0.39 | | | 450 | 31 |
| Comparative | 0.51 | 1.8 | 72 | 340 | 42 |
| Example 1 | | | | | |
| Comparative | 0.40 | 1.157 | 71.8 | 450 | 21 |
| Example 2 | | | | | |
| Comparative | 0.61 | 1.8 | 71.5 | 430 | 20 |
| Example 3 | | | | | |
| Comparative | 0.49 | 0.9 | 72.9 | — | — |
| Example 4 | | | | | |
| Comparative | 0.58 | 1.1 | 72.3 | — | — |
| Example 5 | | | | | |
| Comparative | 0.55 | 1.1 | 71.9 | — | — |
| Example 6 | | | | | |
| Comparative | 0.56 | 1.2 | 59.3 | — | — |
| Example 7 | | | | | |
| Comparative | 0.86 | 1.7 | 72.7 | — | — |
| Example 8 | | | | | |
| Comparative | 0.67 | 1.1 | 71.7 | — | — |
| Example 9 | | | | | |
| Comparative | 0.68 | 1.1 | 71.4 | — | — |
| Example 10 | | | | | |

The molded articles including particles having a rod shape according to Example 1 to Example 3, exhibit remarkably reduced moisture transmittance and improved tensile strength compared with the molded articles without the nucleating agent according to Comparative Example 1. Impact strength may not be substantially reduced and satisfactory impact strength may be maintained.

The molded articles including the particles not having rod shape (e.g., having a sheet shape, a square shape, or a bead shape) do not exhibit reduction of moisture transmittance or exhibit increased moisture transmittance. The results indicate that there is no improvement of moisture transmittance resistance due to inclusion of the nucleating agent. Without being limited by theory, the increase in the moisture transmittance is believed to be caused by an excessive decrease in the crystal size and an increase in the number of crystal nucleation sites due to the nucleating agent, indicating deterioration of the moisture transmittance resistivity.

From the results of Examples 1 to 3 and Comparative Examples 2 to 3 and 5 to 7, a semi-crystallization time is reduced (i.e., crystallization rate is increased) by the addition of the nucleating agent and there is no significant change in crystallinity. The polymer pellet of Comparative Example 2 that include the nucleating agent having a particle size of 30 μm does not exhibit a substantial change in the semi-crystallization time. The polymer pellet of Comparative Example 6 that includes the nucleating agent having a size of 10 μm and an aspect ratio of 1, exhibits reduction in crystallinity. The molded article including the nucleating agent having cubic and bead shape (aspect ratio of 1) exhibits an improved crystallization rate but lower moisture transmission resistivity than the article of Comparative Example 1 without the nucleating agent.

The molded articles of Comparative Examples 2 and 3 that include the nucleating agent having a plate shape, show an increase in moisture transmittance (i.e., deterioration in moisture transmission resistivity). The molded article including plate-shaped clay and graphite as a nucleating agent, exhibits improved moisture transmission resistivity but has a serious decrease in the impact strength.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A battery casing comprising:
a container configured to house an electrode assembly,
wherein
the container comprises a bottom wall and a plurality of side walls,
the bottom wall and the plurality of side walls are integrated to define an open side opposite to the bottom wall and to define a space for housing the electrode assembly,
at least one of the bottom wall and the plurality of side walls comprises a composition comprising a base polymer and a plurality of nucleating agent particles dispersed in the base polymer,
the base polymer comprises a polyethylene polymer,
the nucleating agent particles have a rod shape, an aspect ratio of the nucleating agent particle is greater than or equal to about 2, and
an amount of the nucleating agent particles is greater than or equal to about 0.01 parts by weight and less than or equal to about 3 parts by weight based on 100 parts by weight of the base polymer.

2. The battery casing of claim 1, wherein the container further comprises a plurality of cell compartments separated by at least one partition wall disposed in the space.

3. The battery casing of claim 1, wherein the battery casing further comprises a lid configured to cover at least a portion of the open side of the container and comprising at least one of a positive terminal and a negative terminal.

4. The battery casing of claim 3, wherein the lid comprises a material which is the same as a material of the container.

5. The battery casing of claim 1, wherein the composition comprises the plurality of the nucleating agent particles in an amount of greater than or equal to about 0.04 parts by weight and less than or equal to 1 part by weight, based on 100 parts by weight of the base polymer.

6. The battery casing of claim 1, wherein an average aspect ratio of the plurality of the nucleating agent particles is greater than or equal to about 3.

7. The battery casing of claim 1, wherein an average aspect ratio of the plurality of the nucleating agent particles is less than or equal to about 15.

8. The battery casing of claim 1, wherein an average length of the plurality of the nucleating agent particles is greater than or equal to about 0.5 micrometers and less than or equal to about 20 micrometers.

9. The battery casing of claim 1, wherein at least a portion of the plurality of the nucleating agent particles have a circular or polygonal cross-section.

10. The battery casing of claim 9, wherein a ratio of the circumference of the cross-section of the nucleating agent particle to the thickness of the nucleating agent particle is less than or equal to about 20.

11. The battery casing of claim 1, wherein the nucleating agent particles comprise a metal salt having a hexahydrophthalate moiety, a phosphate metal salt, a titanium-potassium-niobium composite oxide, or a combination thereof.

12. The battery casing of claim 1, wherein the nucleating agent particles do not comprise a surface-treatment comprising an organic compound.

13. The battery casing of claim 1, wherein the polyethylene polymer comprises high density polyethylene.

14. The battery casing of claim 1, wherein a melt flow index of the base polymer is greater than or equal to about 0.01 grams per 10 minutes and less than or equal to about 5 grams per 10 minutes, as measured at 190° C. under a load of 2.16 kilograms.

15. The battery casing of claim 1, wherein a density of the polyethylene polymer is greater than or equal to about 0.9 g/grams per cubic centimeter.

16. The battery casing of claim 1, wherein the at least one of the bottom wall and the plurality of side walls comprising the composition is a molded article.

17. The battery casing of claim 16, wherein the molded article has a crystallinity of greater than or equal to about 71 percent, as measured by a differential scanning calorimeter.

18. The battery casing of claim 16, wherein the molded article has a tensile strength of greater than or equal to about 250 kilogram force per square centimeter, when measured at a tensile speed of 50 millimeters per minute according to ASTM D638.

19. The battery casing of claim 16, wherein the molded article has an impact strength of greater than or equal to about 30 kilojoules per square meter when measured according to ASTM D265.

20. The battery casing of claim 16, wherein the molded article has a water vapor transmittance rate of less than or equal to about 0.5 grams per square meter per day, as measured at 38° C. and a relative humidity of 100% according to ISO 15106 and ASTM F 1249.

21. A battery comprising
the battery casing of claim 1; and
at least one electrode assembly housed in the container of the battery casing.

22. The battery of claim 21, wherein the battery has a modular shape and comprises a plurality of electrode assemblies.
